(19) United States
(12) Patent Application Publication
(10) Pub. No.: US 2006/0207425 A1
(43) Pub. Date: Sep. 21, 2006

(54) Air separation apparatus for contaminated materials

(76) Inventor: Martin Gerardo, Saylorsburg, PA (US)

Correspondence Address: MUSKIN & CUSICK LLC, 1800 CALLOWHILL ST, SUITE 200, PHILADELPHIA, PA, 19130, US

(21) Appl. No.: 11/083,335

(22) Filed: Mar. 17, 2005

(51) Int. Cl. B01D 46/00

(52) U.S. Cl. 95/273

(57) ABSTRACT

An air separation apparatus that separates heavy and light objects by using air pressure. A chamber has a fan or fans which blow debris towards a light object chute. The light objects are more likely to fall into the light object chute. Heavy objects are more likely to fall straight down into a heavy object chute.

### INCORPORATIONS BY REFERENCE

This application incorporates by reference disclosure document no. 564,569, entitled “Air Separation Apparatus for Contaminated Materials,” deposited with the USPTO on Nov. 8, 2004.

### BACKGROUND OF THE INVENTION

1. Field of the Invention

The present invention is directed to an apparatus to automatically separate light objects and heavy objects without a need for manual labor.

2. Description of the Related Art

U.S. Pat. No. 5,107,556, to Schmid, has an issue date of Apr. 28, 1992. The patent is directed towards a discharge blower chute and method. The blower is used to blow leaves in a desired direction. The debris such as leaves end up being mulched while being processed in the chute, thereby reducing them in size.

U.S. Pat. No. 5,768,743, to Webster, has an issue date of Jun. 23, 1998. The patent is directed towards a debris collecting apparatus. A motor drives an impeller to generate an air stream. The air stream blows through an air supply duct which blows debris into a collecting bag. The device can be switched between a blowing mode and a vacuum mode.

### SUMMARY OF THE INVENTION

It is an aspect of the present invention to provide an apparatus and method to automatically separate heavy objects and light objects.

The above aspects can also be obtained by an apparatus that includes (a) a chamber having an opening; (b) a first blowing apparatus on a first side of the chamber; (c) a first chute under the chamber; and (d) a second chute opposite the first blowing apparatus.

The above aspects can also be obtained by a method that includes (a) introducing debris comprising heavy objects and light objects into a chamber; (b) blowing the light objects in a first direction; (c) collecting the light objects in a first chute located towards the direction; and (d) collecting the heavy objects in a second chute.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a drawing illustrating an air separation apparatus, according to an embodiment;

FIG. 2 is a drawing illustrating a side view of an air separation apparatus, according to an embodiment;

FIG. 3 is a drawing illustrating another side view of an air separation apparatus, according to an embodiment;

FIG. 4 is a drawing illustrating a further view of an air separation apparatus, according to an embodiment;

FIG. 5 is a drawing illustrating a rear view of an air separation apparatus, according to an embodiment; and

FIG. 6 is a drawing illustrating a perspective view of an air separation apparatus, according to an embodiment.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

The present general inventive concept relates to an air separation apparatus for contaminated materials or materials that contain objects of different weights or densities.

Bagged leaves can be processed and turned into compost, which can be used as a fertilizer or other organic uses. The bagged leaves can be ground in a tub grinder. The result is little pieces of leaves can be aged and will break down into compost (a black soil). This process may take around six months. The compost can have numerous uses, such as a natural fertilizer.

The compost also can contain larger pieces of refuse mixed in (“heavies”) such as pieces of wood, etc. The compost can be separated from the heavies by running the compost through a screen. The larger items can stay stuck on top of the screen while the liquid part (or finished product) can run through the screen to the bottom.

The “heavies” can contain large pieces of wood and other refuse mixed in with pieces of plastic and paper (which can come from the original bagged leaves which were ground). It is desirable to separate the pieces of paper (light objects) from the heavy objects, as the pieces of paper can be discarded while the heavier objects may still find uses (e.g. wood, metal, etc.)

Thus, the present invention relates to an apparatus and method to automatically separate light items from heavy objects. The combined light items and heavy objects can be called mixed objects. Previously, bagged leaves would have to manually separated from the bag before bring processed. With an apparatus as currently described, the bagged leaves can be ground in the bag and the bag pieces can be separated automatically at a later time.

The present invention can be used for a variety of uses in addition to the one described previously. For example, it can be used to process car fluff, that is processed car pieces. Machines grind up pieces of junked cars, and the heavier parts (e.g. metal) can be separated from the lighter parts (e.g. plastic). The invention can also be used to separate recycled plastic and glass. The invention can also be used in any other context where objects of different weights (or other characteristics such as drag) are desirous of being automatically separated.

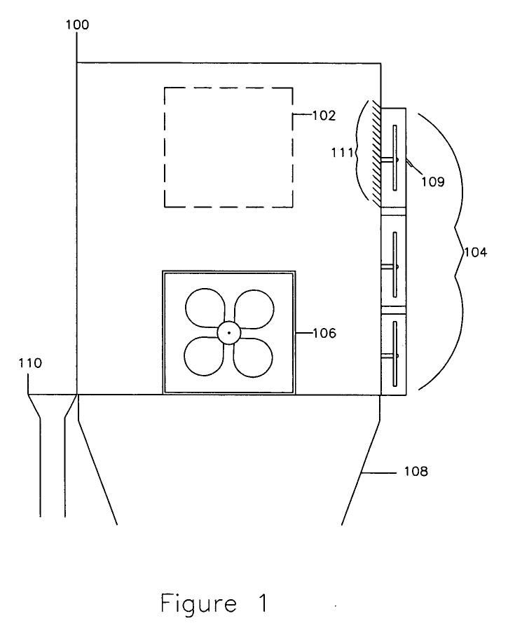

FIG. 1 is a drawing illustrating an air separation apparatus, according to an embodiment.

An air separation apparatus 100 can be used to separate light objects and heavy objects from mixed objects. The mixed objects enter the air separation apparatus 100 through an opening 102. A conveyor belt (or any other type of apparatus can be used including throwing objects in by hand) is used to introduce the mixed objects into the air separation apparatus 100.

A series of small fans 104 can be used to blow the mixed objects award from the small fans 104. Any number of fans (or blowers) can be used for the small fans, such as one, two, three, four, etc., and the fan(s)/blower(s) do not necessarily have to be small.

A light object chute 110 can be used to collect light objects. The light objects are typically blown by the small fans 104 towards the light object chute 110. The heavy objects by nature are less affected by the small fans 104 and should drop into the heavy object chute 108.

A large fan 106 can be perpendicular to the small fans 104 and can be used to generate additional lift for the mixed/heavy/light objects in the air separation apparatus 100. The additional lift can be advantageous in ensuring that the light objects do not fall into the heavy object chute 108. Light objects that are about to fall into the heavy object chute 108 can be subjected to additional lift by the large fan 106 which contributes to subjecting the light objects to the small fans 104 which should blow the light objects to the light object chute 110. Netting can be attached to the unit to catch light objects to prevent them from blowing away.

Blowers can also be in place of fans. The speed/output of the blowers or fans can be adjusted by an operator. Louvers can also be used to direct an air stream so that waste can be blown to a netting system which can catch the waste. Louver adjuster 109 can be used to adjust the louvers 111 of the top small fan of the small fans 104. The louver adjuster 109 can be pulled (or pushed) in a direction which cause the louvers to move accordingly. Each of the other fans (whether small or big) can also have adjustable louvers. The louvers can be used to optimally adjust the air flow to achieve maximum accuracy of the apparatus.

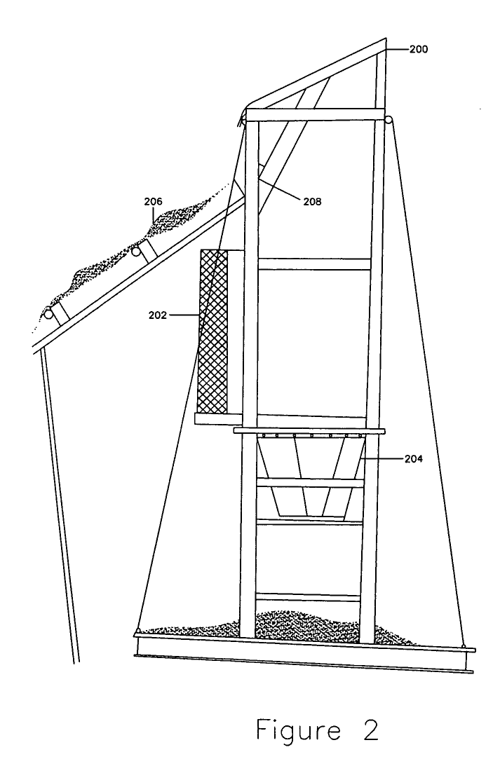

FIG. 2 is a drawing illustrating a side view of an air separation apparatus, according to an embodiment.

A conveyor belt 206 can be used to introduce mixed objects into the air separation apparatus 200. An opening 208 in the air separation apparatus 200 allows the debris on the conveyor belt 206 to be introduced into the air separation apparatus 200. A netting 202 can be used to catch debris which may fall off the conveyor belt 206 before entering the opening 208. A light object chute 204 is used to collect the light objects.

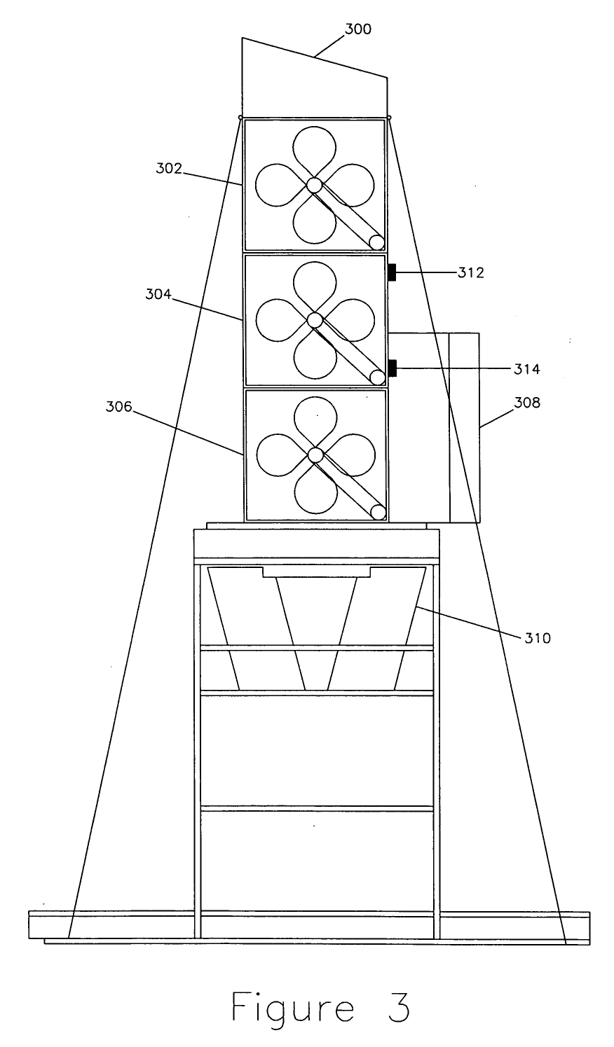

FIG. 3 is a drawing illustrating another side view of an air separation apparatus, according to an embodiment.

The air separation apparatus 300 can have three small fans 302 304 306 (although any number can be used) and a large fan 208 that is perpendicular to the three small fans 302 304 306. A heavy object chute 310 is under the air separation apparatus 300 to capture the heavy items.

Note that fan speed controls 312 and 314 on the right side of the fan 304. These controls can be located anywhere. The controls can be used to control the small fans and also the big fans. The fans speed can be adjusted to produce an ideal balance of speed of operation of the apparatus and accuracy. The direction the fans/blowers are blowing can be adjusted by louvers (not pictured) as well. The air stream(s) can be adjusted with respect to the angle of attach thereof as it confronts falling waste material. A louver type series of thin blades can be used to direct and adjust the air stream.

There can be two air streams, a first air stream towards the chute for the lighter objects and a second air stream (substantially perpendicular to the first air stream) which generates additional lift before objects fall into the center chute. Adjusting the strength of both air streams, and their directions, can result in a system that operates accurately and efficiently.

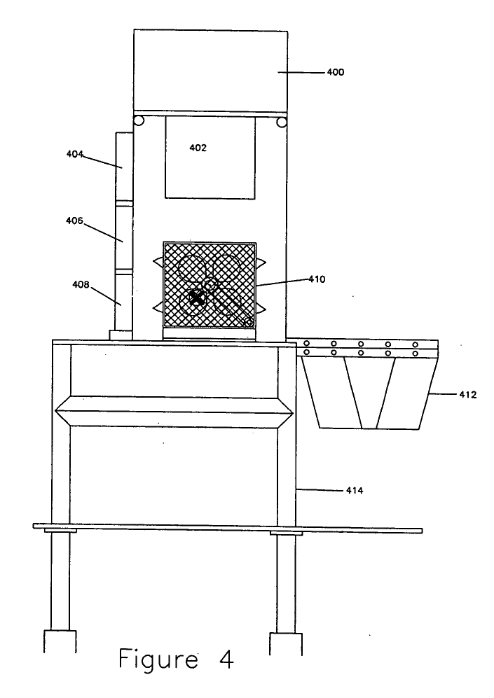

FIG. 4 is a drawing illustrating a further view of an air separation apparatus, according to an embodiment.

An opening 402 allows debris to enter into the air separation apparatus 400. Three small fans 404 406 408 can be used to blow debris towards the light object chute 412. A large fan 410 can be used to blow light objects about to fall into the heavy object chute (not pictured) back towards the three small fans 404 406 408. A stand 414 can be used to elevate the air separation apparatus 400.

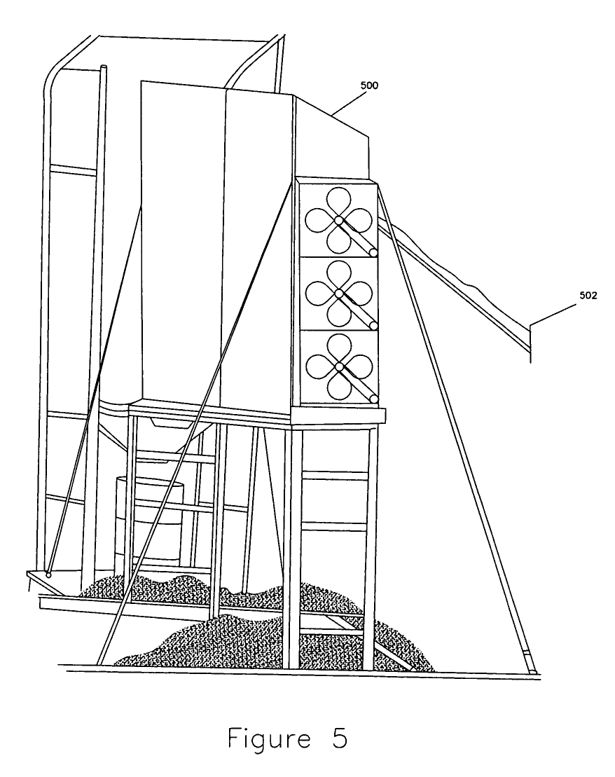

FIG. 5 is a drawing illustrating a rear view of an air separation apparatus, according to an embodiment.

A conveyor belt 502 can be used to introduce debris into the air separation apparatus.

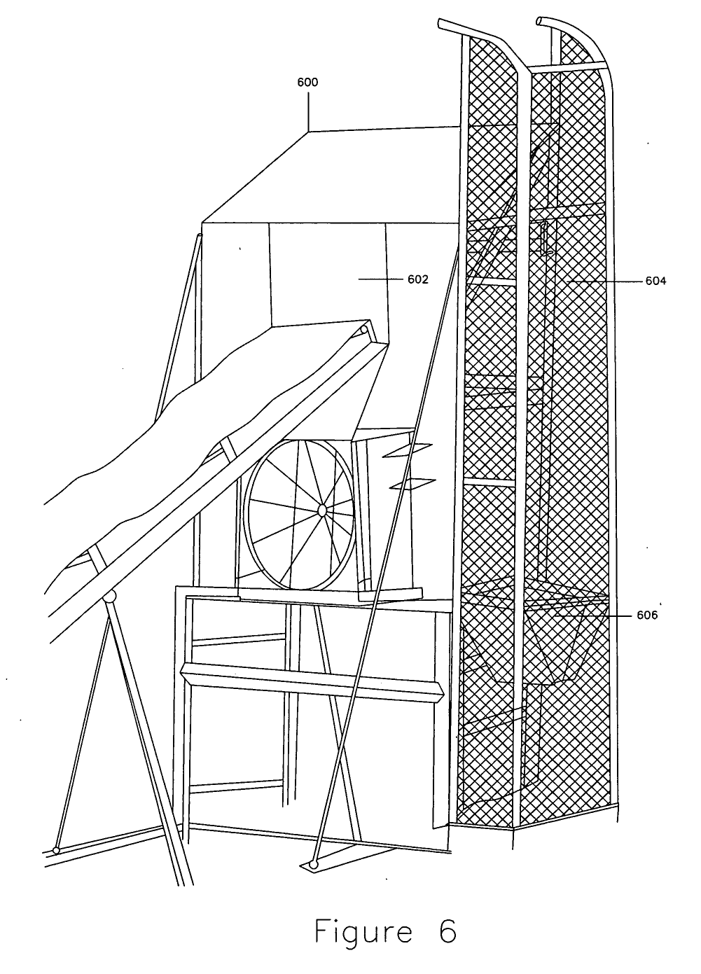

FIG. 6 is a drawing illustrating a perspective view of an air separation apparatus, according to an embodiment.

An opening 602 in the air separation apparatus 600 allows debris to enter to be automatically separated into its heavy object and light object components. A netting 604 can be used to capture light objects and direct them into the light object chute 606.

The configurations described herein are merely examples, and different sizes or numbers of fans, dimensions, etc. can be used in achieving the present general inventive concept as well.

The air separation unit can be 8′×29″ wide and 10′ high, which can be made of metal (or wood, etc.) The three fans pictured can be 24″ fans (with a power of each 8500 cfm). The one big fan can be a 48″ fan (with a power of 20,500 cfm). The inside of the air separation apparatus can be 29″ wide. The unit can also be built with 4 small fans (in a 10 foot area). The fan louvers can be adjusted to attain optimal performance of the apparatus. For example, the big fan can be adjusted to blow air at a 45 degree angle from the bottom plane. With the three or four smaller fans, the bottom small fan can blow air at a few degrees upwards from the bottom plane (e.g. the bottom plane being 0 degrees), while the other fans can blow air horizontally (0 degrees).

The louvers can also be used to ensure that the waste is caught by the netting and does not blow outside the perimeter of the apparatus.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A separation apparatus, the apparatus comprising:
a chamber having an opening;
a first blowing apparatus on a first side of the chamber;
a first chute under the chamber; and
a second chute opposite the first blowing apparatus.

2. An apparatus as recited in claim 1, further comprising:
a second blowing apparatus on a second side of the chamber perpendicular to the first side.

3. An apparatus as recited in claim 2, further comprising:
a conveyor belt introducing debris into the opening.

4. An apparatus as recited in claim 1, wherein the first blowing apparatus comprises three fans.

5. An apparatus as recited in claim 1, further comprising a first speed adjuster adjusting an output of the first blowing apparatus.

6. An apparatus as recited in claim 2, further comprising a second speed adjuster adjusting an output of the second blowing apparatus.

7. An apparatus as recited in claim 1, further comprising a first lever to adjust a blowing direction of the first blowing apparatus.

8. An apparatus as recited in claim 2, further comprising a second lever to adjust a blowing direction of the second blowing apparatus.

9. A separation method, comprising:
introducing debris comprising heavy objects and light objects into a chamber;
blowing the light objects in a first direction;
collecting the light objects in a first chute located towards the direction; and
collecting the heavy objects in a second chute.

10. A method as recited in claim 9, wherein the second chute is located under the chamber.

11. A method as recited in claim 9, further comprising:
blowing the light objects in a second direction perpendicular to the first direction.
